(19) United States
(12) Patent Application Publication
(10) Pub. No.: US 2010/0057979 A1
(43) Pub. Date: Mar. 4, 2010

(54) DATA TRANSMISSION METHOD FOR FLASH MEMORY AND FLASH MEMORY STORAGE SYSTEM AND CONTROLLER USING THE SAME

(75) Inventors: Chien-Hua Chu, Hsinchu County (TW); Chih-Kang Yeh, Kinmen County (TW); Ruei-Cian Chen, Taipei County (TW); Kian-Fui Seng, Miaoli (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/327,078

(22) Filed: Dec. 3, 2008

(30) Foreign Application Priority Data
Aug. 27, 2008 (TW) 97132789

(51) Int. Cl. G06F 12/02; G06F 12/00

(52) U.S. Cl. 711/103; 711/E12.001; 711/E12.002

(57) ABSTRACT

A data transmission method suitable for transmitting data from a cache to a plurality of flash memory groups through a single data bus in a flash memory storage system is provided. The data transmission method includes sequentially sorting and grouping data to be written at continuous logical addresses in the cache in unit of logical blocks. The data transmission method further includes respectively transmitting the grouped sector data into the flash memory groups through the data bus in an interleaving manner, wherein data in the same logical block is transmitted and written into physical blocks of the same flash memory group. Thereby, the data is prevented from being written into different physical blocks, and accordingly the lifespan of the flash memory storage system is prolonged.

### CROSS-REFERENCE TO RELATED APPLICATION

This application claims the priority benefit of Taiwan application serial no. 97132789, filed Aug. 27, 2008. The entirety of the above-mentioned patent application is hereby incorporated by reference herein and made a part of this specification.

### BACKGROUND

1. Technology Field

The present invention generally relates to a data transmission method for a flash memory, and a flash memory storage system and a controller using the same, and more particularly, to a data transmission method for writing data into a flash memory chip having a plurality of flash memory dies through a single data bus and a flash memory storage system and a controller using the same.

2. Description of Related Art

Along with the widespread of digital cameras, camera phones, and MP3 in recently years, the consumers' demand to storage media has increased drastically too. Flash memory is one of the most adaptable memories for such battery-powered portable products due to its characteristics such as data non-volatility, low power consumption, small volume, and non-mechanical structure. A solid state drive (SSD) is a storage device which uses a NAND flash memory as its storage medium.

Generally speaking, a flash memory die in a flash memory chip of a flash memory storage system is usually divided into a plurality of physical units, and each of the physical units is usually composed of one or multiple physical blocks. These physical units are usually grouped into a data area and a spare area. Physical units in the data area are used for storing valid data written by write commands, and physical units in the spare area are used for substituting the physical units in the data area when the write commands are executed. To be specific, when a flash memory storage system receives a write command from a host system and is about to write a data into a physical unit in the data area, the flash memory storage system selects a physical unit from the spare area and writes both the valid old data in the physical unit in the data area and the new data into the physical unit selected from the spare area. After that, the flash memory storage system links the physical unit containing the new data to the data area, and meanwhile, the flash memory storage system erases the original physical unit in the data area and links it to the spare area. In order to allow the host system to access the physical units which are used alternatively for storing data, the flash memory storage system provides logical units to be accessed by the host system, wherein the logical units are provided in unit of one or multiple physical blocks according to the size of the physical units. To be specific, the flash memory storage system establishes a logical-physical address mapping table and records and updates the mapping relationship between the logical units and the physical units in the data area in this table to reflect the alternation of the physical units. Accordingly, the host system needs only to access the logical units while the flash memory storage system accesses the corresponding physical units according to the logical-physical address mapping table.

However, the capacity of each physical block has been increased along with the advancement of flash memory process, and as a result, the time required for moving foregoing valid old data has been increased correspondingly. Namely, the time for a flash memory storage system to program a flash memory die has also been increased. According to a conventional technique, in order to increase the write speed of a flash memory storage system, a plurality of flash memory dies is packaged into a single flash memory chip, and when a large quantity of data is written, the data is alternatively written into the flash memory dies through an interleaving programming method. To be specific, the time required for transmitting data to a flash memory die through a data bus is far less than the time required for programming the flash memory die. Accordingly, a buffer is usually disposed in each flash memory die, and when a controller of the flash memory storage system writes data into the flash memory die, the data is first transmitted into the buffer and then programmed (i.e., written) into physical blocks of the flash memory die, wherein the flash memory die is referred to as in a busy state during the data is written into the physical blocks of the flash memory die. Therefore, in the a flash memory storage system including a flash memory chip having a plurality of flash memory dies, the controller of the flash memory storage system can divide a data into a plurality of sub data, then sequentially transmit the sub data into the buffers of those flash memory dies that are not in the busy state in an interleaving manner, and then write the sub data respectively into the physical blocks of these flash memory dies. As a result, the time required for writing a large quantity of data can be reduced.

However, in the method described above, data at continuous logical addresses (i.e., in the same logical block) may be written into physical blocks of different flash memory dies. Accordingly, when subsequently the controller is about to update the data in only one of the logical blocks, the controller still has to update and move data in multiple physical blocks. As a result, the time required for writing data is increased. In addition, since erasing operations have to be performed to the multiple physical blocks while updating the data, the wear of the physical blocks may be increased and accordingly the lifespan of the flash memory storage system may be reduced.

### SUMMARY

Accordingly, the present invention is directed to a data transmission method which can improve the efficiency of data writing and reduce the wear of physical blocks.

The present invention is also directed to a controller which transmits data through foregoing data transmission method so that the efficiency of data writing can be improved and the wear of physical blocks can be reduced.

The present invention is further directed to a flash memory storage system which transmits data through foregoing data transmission method so that the efficiency of data writing can be improved and the wear of physical blocks can be reduced.

The present invention provides a data transmission method for a flash memory storage system. The flash memory storage system has a plurality of physical blocks, the physical blocks are grouped into a plurality of flash memory groups, and the flash memory groups are connected to a single data bus. The data transmission method includes following steps. First, a plurality of logical sectors and a plurality of logical blocks are provided, wherein the logical sectors are mapped to the logical blocks, and the logical blocks are mapped to the physical blocks. Then, sector data to be written in the continuous logical sectors is sequentially grouped into a plurality of block data, wherein each of the block data is corresponding to one of the logical blocks. Next, the sector data belonging to the same block data is transmitted and written into the same physical blocks.

The present invention also provides a flash memory storage system and a controller thereof. The flash memory storage system includes a plurality of physical blocks, at least one data bus, a cache, a connector, and the controller, wherein the physical blocks are grouped into a plurality of flash memory groups, and the data bus is connected to the flash memory groups. The controller is electrically connected to the cache, the data bus, and the connector. The controller includes a microprocessor unit, a flash memory interface module coupled to the microprocessor unit, a buffer memory, a host interface module, and a memory management module, wherein the memory management module has a plurality of machine instructions, which when executed by the microprocessor unit, to accomplish foregoing data transmission method to a flash memory.

In the present invention, data in a cache is sorted and grouped in unit of logical blocks according to the logical addresses thereof, and the grouped data is transmitted into a plurality of flash memory dies of a flash memory chip in an interleaving manner. Accordingly, data to be written at continuous logical addresses can be written into the physical blocks of the same flash memory die when the flash memory storage system writes the data through an interleaving programming method. Thereby, the efficiency of data writing can be improved when subsequently the data is updated and the number of erasing operations performed to the physical blocks can be reduced.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram of a flash memory storage system according to an exemplary embodiment of the present invention.

FIG. 2 is a block diagram of a flash memory chip according to an exemplary embodiment of the present invention.

FIG. 3A is a schematic diagram of physical blocks in a flash memory chip according to an exemplary embodiment of the present invention.

FIG. 3B is an operational diagram of physical blocks in a flash memory chip according to an exemplary embodiment of the present invention.

FIG. 4A illustrates an example about how data is transmitted from a cache to a flash memory chip according to an exemplary embodiment of the present invention.

FIG. 4B is a timing diagram of an interleaving programming method performed in the example illustrated in FIG. 4A.

FIG. 5 is a flowchart of data transmission steps according to an exemplary embodiment of the present invention.

### DESCRIPTION OF THE EXEMPLARY EMBODIMENTS

Reference will now be made in detail to the present preferred exemplary embodiments of the invention, examples of which are illustrated in the accompanying drawings. Wherever possible, the same reference numbers are used in the drawings and the description to refer to the same or like parts.

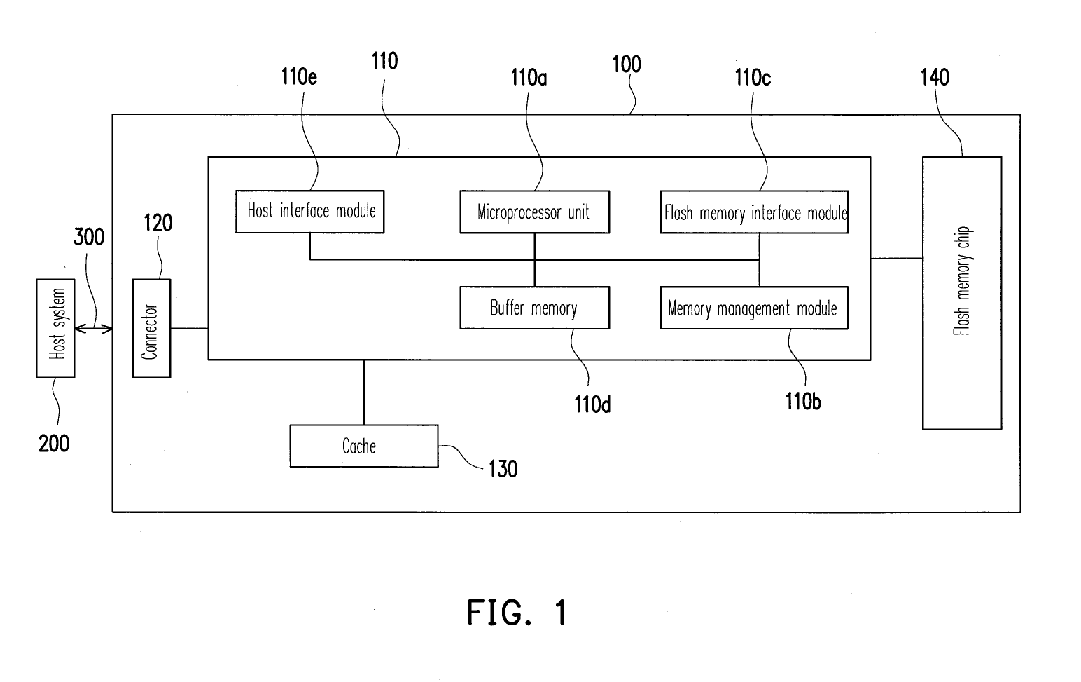

FIG. 1 is a schematic block diagram of a flash memory storage system according to an exemplary embodiment of the present invention. Referring to FIG. 1, the flash memory storage system 100 includes a controller (also referred to as a controller system) 110, a connector 120, a cache 130, and a flash memory chip 140.

The flash memory storage system 100 usually works together with a host system 200 to allow the host system 200 to write data into or read data from the flash memory storage system 100. In the present exemplary embodiment, the flash memory storage system 100 is a solid state drive (SSD). However, in another exemplary embodiment of the present invention, the flash memory storage system 100 may also be a flash memory card or a flash drive.

The controller 110 executes a plurality of machine instructions implemented as hardware or firmware to work together with the connector 120, the cache 130, and the flash memory chip 140 for storing, reading, and erasing data. The controller 110 includes a microprocessor unit 110a, a memory management module 110b, a flash memory interface module 110c, a buffer memory 110d, and a host interface module 110e.

The microprocessor unit 110a cooperates with the memory management module 110b, the flash memory interface module 110c, the buffer memory 110d, and the host interface module 110e to carry out various operations of the flash memory storage system 100.

The memory management module 110b is coupled to the microprocessor unit 110a. The memory management module 110b has a plurality of machine instructions which can be executed by the microprocessor unit 110a for managing the flash memory chip 140, such as performing a wear levelling function, managing bad blocks, and maintaining a logical-physical address mapping table, etc. Particularly, in the present exemplary embodiment, the memory management module 110b has machine instructions which can be executed to accomplish the data transmission steps in the present exemplary embodiment.

In the present exemplary embodiment, the memory management module 110b is implemented in the controller 110 as a firmware. For example, the memory management module 1 10b can be implemented as machine instructions written in a programming language and stored in a program memory (for example, a read-only memory, ROM). When the flash memory storage system 100 is in operation, the machine instructions of the memory management module 110b may be indirectly loaded into the buffer memory 110d and then executed by the microprocessor unit 110a or directly executed by the microprocessor unit 110a to accomplish aforementioned wear leveling function, bad block management function, and logical-physical address mapping table maintenance function, etc. In particular, the controller 110 executes a plurality of machine instructions of the memory management module 110b to accomplish the data transmission steps in the present exemplary embodiment.

In another exemplary embodiment of the present invention, the machine instructions of the memory management module 110b may also be stored in a specific area of the flash memory chip 140 (for example, a system area in the flash memory used exclusively for storing system data) as a firmware. Similarly, when the flash memory storage system 100 is in operation, the machine instructions of the memory management module 110b are loaded into the buffer memory 110d and executed by the microprocessor unit 110a. Additionally, in another exemplary embodiment of the present invention, the memory management module 110b may also be implemented in the controller 110 as hardware.

The flash memory interface module 110c is coupled to the microprocessor unit 110a for accessing the flash memory chip 140. Namely, data to be written into the flash memory chip 140 is converted by the flash memory interface module 110c into a format acceptable to the flash memory chip 140.

The buffer memory 110d is coupled to the microprocessor unit 110a for temporarily storing system data (for example, the logical-physical address mapping table) or data to be written or read by the host system 200. In the present exemplary embodiment, the buffer memory 110d is a static random access memory (SRAM). However, the present invention is not limited thereto, and a dynamic random access memory (DRAM), a magnetoresistive random access memory (MRAM), a phase change random access memory (PRAM), or other suitable memories may also be applied to the present invention.

The host interface module 110e is coupled to the microprocessor unit 110a for receiving and identifying a command from the host system 200. Namely, the command and data received from the host system 200 are transmitted to the microprocessor unit 110a through the host interface module 110e. In the present exemplary embodiment, the host interface module 110e is a PCI Express interface. However, the present invention is not limited thereto, and the host interface module 110e may also be a USB interface, an IEEE 1394 interface, a SD interface, a MS interface, a MMC interface, a SATA interface, a PATA interface, a CF interface, an IDE interface, or other suitable data transmission interfaces. In particular, the host interface module 10e is corresponding to the connector 120. Namely, the host interface module 110e has to match the connector 120.

In addition, even though not shown in the present exemplary embodiment, the controller 110 may further include other general function modules for controlling the flash memory chip, such as an error correction module and a power management module.

The connector 120 is electrically connected to the controller 110 for connecting to the host system 200 through a bus 300. In the present exemplary embodiment, the connector 120 is a PCI Express connector. However, the present invention is not limited thereto, and the connector 120 may also be a USB connector, an IEEE 1394 connector, a SD connector, a MS connector, a MMC connector, a SATA connector, a CF connector, an IDE connector, a PATA connector, or other suitable connectors.

The cache 130 is electrically connected to the controller 110 for temporarily storing data received from the host system 200 to increase the access speed of the flash memory storage system 100. In the present exemplary embodiment, the cache 130 is a DRAM. However, the present invention is not limited thereto, and in another exemplary embodiment of the present invention, the cache 130 may also be a double data rate DRAM (DDR DRAM).

The flash memory chip 140 is electrically connected to the controller 110 for storing data. In the present exemplary embodiment, the flash memory chip 140 is a multi level cell (MLC) NAND flash memory chip. However, the present invention is not limited thereto, and in another exemplary embodiment of the present invention, the flash memory chip 140 may also be a single level cell (SLC) NAND flash memory chip.

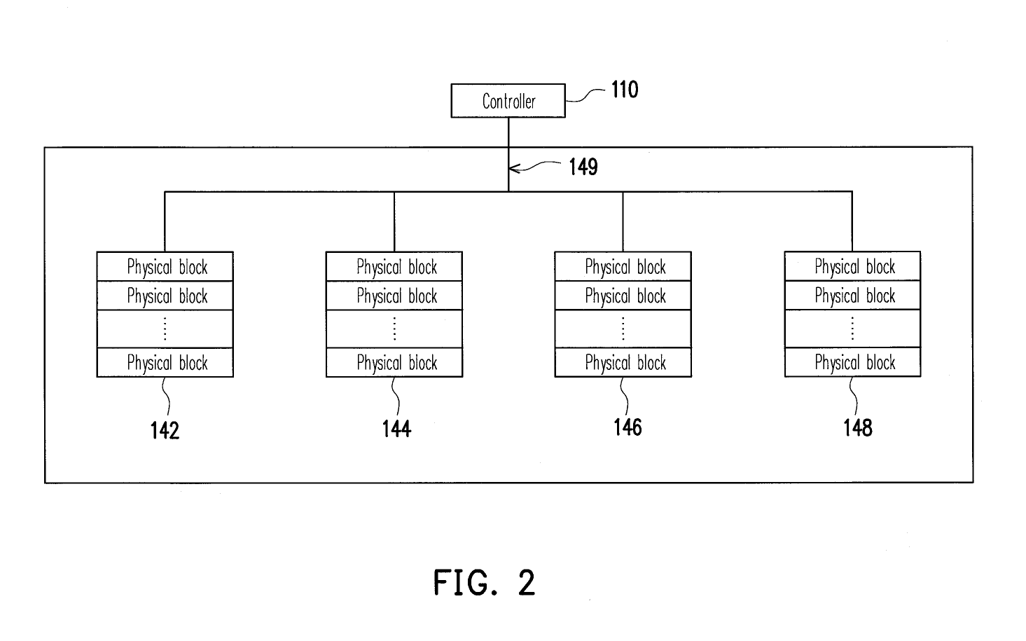

FIG. 2 is a block diagram of a flash memory chip according to an exemplary embodiment of the present invention. In the present exemplary embodiment, the flash memory chip 140 includes a first flash memory die 142, a second flash memory die 144, a third flash memory die 146, a fourth flash memory die 148, and a data bus 149 for transmitting data between the controller 110 and the flash memory chip 140. In the present exemplary embodiment, the first flash memory die 142, the second flash memory die 144, the third flash memory die 146, and the fourth flash memory die 148 are respectively enabled by a chip enable (CE) pin (not shown). However, the present invention is not limited thereto, and in another exemplary embodiment of the present invention, one CE pin may enable multiple flash memory dies, and herein the flash memory dies enabled by the same CE pin are referred to as a flash memory group. In the present exemplary embodiment, since the first flash memory die 142, the second flash memory die 144, the third flash memory die 146, and the fourth flash memory die 148 are respectively enabled by a CE pin, each flash memory die is referred to as one flash memory group.

For the convenience of management, the controller 110 of the flash memory storage system 100 divides the first flash memory die 142, the second flash memory die 144, the third flash memory die 146, and the fourth flash memory die 148 into a plurality of physical units. Generally, each of the physical units includes one or multiple physical blocks, and the physical blocks are managed in unit of physical units. In the present exemplary embodiment, one physical unit only includes one physical block. Accordingly, in the present exemplary embodiment, the flash memory is managed in unit of physical blocks. However, the present invention is not limited thereto, and in another exemplary embodiment of the present invention, a flash memory die may be composed of a plurality of planes, and a physical unit is composed of physical blocks on different planes, and in this case, the flash memory die is accessed in a multi plane access mode.

A physical block is the smallest unit for erasing data from a flash memory. Namely, each physical block contains the least memory cells which are erased together. A physical block is usually divided into a plurality of pages, and each page is the smallest unit for programming the flash memory. However, it should be noted that in some different flash memory designs, the smallest programming unit may also be sector. Namely, each page contains a plurality of sectors and each sector serves as the smallest programming unit. In other words, in the present exemplary embodiment, page is the smallest unit for writing or reading data. Each page is usually divided into a user data area D and a redundant R. The user data area D is used for storing user data, and the redundant area R is used for storing system data (for example, an error correcting code, ECC).

Generally, the user data area D has 512 bytes and the redundant area R has 16 bytes in order to correspond to the size of sectors in a disk drive. Namely, a page is a sector. However, a page may also be composed of a plurality of sectors. In the present exemplary embodiment, a page is composed of four sectors.

Generally speaking, a physical block may be composed of any number of pages, such as 64 pages, 128 pages, and 256 page, etc. In the present exemplary embodiment, a physical block is composed of 256 pages. In addition, the physical blocks in the first flash memory die 142, the second flash memory die 144, the third flash memory die 146, and the fourth flash memory die 148 are usually grouped into several zones. By managing operations of a flash memory based on zones, parallelism of the operations can be increased and the management thereof can be simplified.

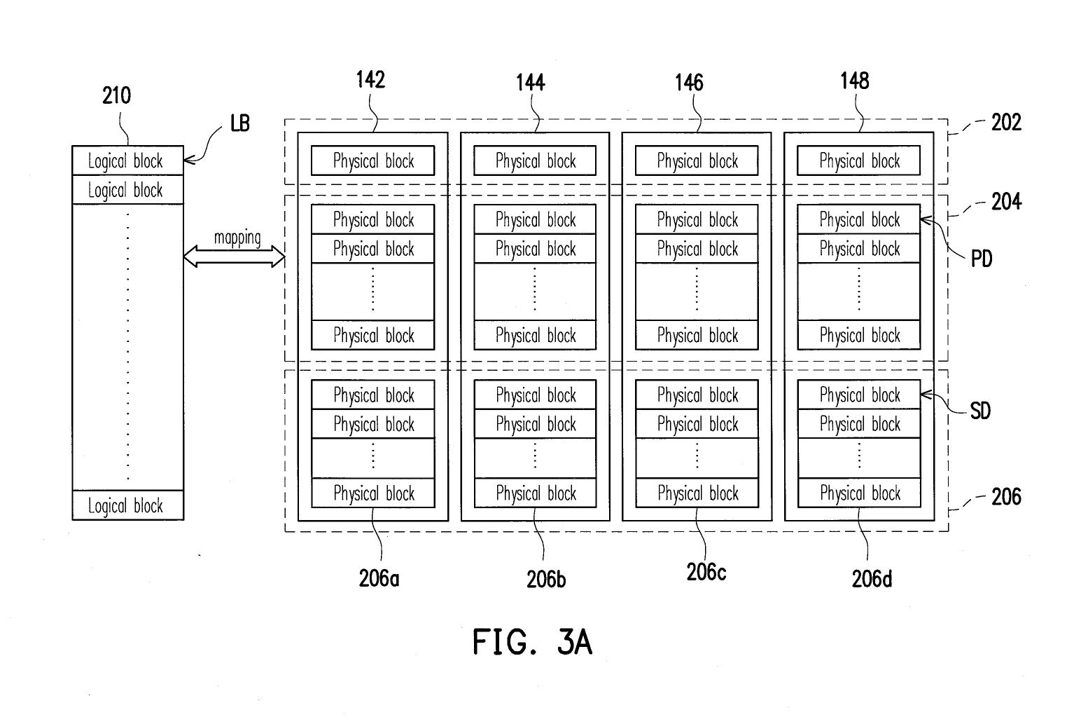

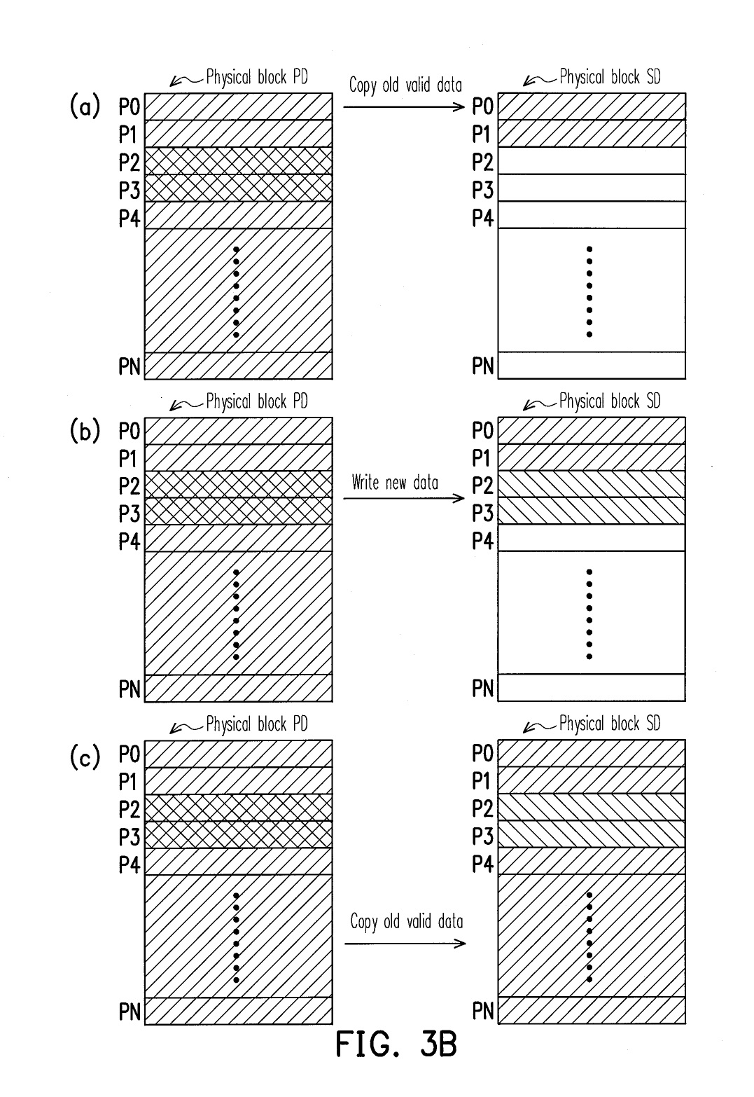

FIG. 3A is a schematic diagram of physical blocks in the flash memory chip 140 according to an exemplary embodiment of the present invention.

It should be understood that in following descriptions, the terms like “select”, “move”, “exchange”, “substitute”, “alternate”, “partition”, and “divide” are only used for describing the operations performed to the physical blocks in the flash memory chip 140 in a logical concept. In other words, the actual positions of the physical blocks in the flash memory are not changed; instead, the operations are logically performed to the physical blocks in the flash memory. It should be mentioned herein that the following operations performed to the physical blocks are accomplished by executing the machine instructions of the memory management module 110b through the controller 110.

Referring to FIG. 3A, in the present exemplary embodiment, in order to program (write) data efficiently, the controller 110 logically groups the physical blocks in the first flash memory die 142, the second flash memory die 144, the third flash memory die 146, and the fourth flash memory die 148 into a system area 202, a data area 204, and a spare area 206. As described above, the physical blocks in the first flash memory die 142, the second flash memory die 144, the third flash memory die 146, and the fourth flash memory die 148 are alternatively provided to the host system 200 for storing data. Thus, the controller 110 provides a plurality of logical addresses to the host system 200 and records the mapping relationship between the logical addresses and the corresponding physical blocks in a logical-physical address mapping table.

To be specific, in the present exemplary embodiment, the flash memory chip 140 is managed in unit of physical blocks. Accordingly, the controller 110 manages the logical-physical address mapping table by the logical blocks 210. In addition, the host system 200 accesses data in unit of sectors. Thus, the controller 110 provides the logical addresses to the host system 200 in unit of logical sectors. Besides, the controller 110 converts the logical addresses in unit of logical sectors into logical addresses in unit of logical blocks and accesses data in the pages of the physical blocks in the flash memory dies according to the logical-physical address mapping table.

Physical blocks in the system area 202 are used for recording system data, such as the number of zones in each flash memory die, the number of physical blocks in each zone, the number of pages in each physical block, and the logical-physical address mapping table for recording the mapping relationship between logical addresses and physical addresses, etc.

Physical blocks in the data area 204 are used for storing user data. Generally speaking, these physical blocks are mapped to the logical blocks 210 accessed by the host system 200.

Physical blocks in the spare area 206 are used for substituting the physical blocks in the data area 204. Thus, the physical blocks in the spare area 206 are blank or available blocks. Namely, no data is recorded in these blocks or data recorded in these blocks is marked as invalid data.

Particularly, the physical blocks in the data area 204 and the spare area 206 are alternatively used for storing data written into the flash memory storage system 100 by the host system 200. To be specific, each physical address in the flash memory can only be programmed once. Thus, to write a new data into an address which already contains data, an erasing operation has to be performed to the address first. However, as described above, data is written into a flash memory in unit of pages while erased from the same in unit of physical blocks. Since the writing unit is smaller than the erasing unit, when an erasing operation is to be performed to a physical block, data in valid pages of the physical block has to be copied into another physical block before the physical block is erased.

FIG. 3B is an operational diagram of physical blocks in a flash memory chip according to an exemplary embodiment of the present invention.

Referring to both FIG. 3A and FIG. 3B, for example, when the host system is about to write a data into the logical block LB, assuming that the controller 110 gets to know that the logical block LB is currently mapped to the physical block PD in the data area 204 according to the logical-physical address mapping table, the flash memory storage system 100 updates the data in the physical block PD. Meanwhile, the controller 110 selects a physical block SD from the spare area 206 for substituting the physical block PD in the data area 204. However, when the controller 110 writes the new data into the physical block SD, it does not move all the valid data in the physical block PD instantly to the physical block SD to erase the physical block PD. To be specific, the controller 110 copies the valid data (i.e., pages P0 and P1) before the page for writing the new data in the physical block PD into the physical block SD (as shown in FIG. 3B(a)) and writes the new data into the physical block SD (i.e., pages P2 and P3 in the physical block SD) (as shown in FIG. 3B(b)). Herein, the physical block SD containing part of the old valid data and the new data is in a temporarily state, and the physical block PD and the physical block SD are referred to as mother-child blocks. This temporary relationship is maintained because the valid data in the physical block PD may become invalid in the next operation (for example, the next write command) and accordingly it may become meaningless to move all the valid data in the physical block PD instantly to the physical block SD. The operation for temporarily maintaining such a temporary relationship is usually referred to as “opening” mother-child blocks.

Thereafter, the controller 110 integrates the physical block PD and the physical block SD into one physical block only when the contents of the physical block PD and the physical block SD are to be actually combined, so that the efficiency in using these blocks can be improved. Such an integration operation is also referred to as closing mother-child blocks. For example, as shown in FIG. 3B(c), while closing the mother-child blocks, the controller 110 copies the remaining valid data in the physical block PD (i.e. pages P4˜PN) into the physical block SD and then erases the physical block PD and links it to the spare area 206. At the same time, the controller 110 links the physical block SD to the data area 204 and updates the logical-physical address mapping table to reflect that the logical block LB is mapped to the physical block SD. By now, the alternation (or substitution) between the physical block PD and the physical block SD is completed.

While opening mother-child blocks, the flash memory storage system 100 stores information about this temporary relationship to be accessed subsequently. Thus, the number of mother-child blocks which can be opened is determined according to the capacity of the buffer memory 110d in the controller 110. For example, in the present exemplary embodiment, the flash memory storage system 100 maintains at most five sets of mother-child blocks. In other words, when the flash memory storage system 100 has opened five sets of mother-child blocks and the host system 200 issues a write command to the flash memory storage system 100, if the logical block to be written by the host system 200 is not mapped to a mother-child block, the controller 110 closes one set of the mother-child blocks and opens another set of mother-child blocks to execute the write command.

It should be understood that in the present exemplary embodiment, the flash memory chip 140 is managed in unit of physical blocks. Thus, foregoing operations of storing data alternatively (i.e., opening and closing mother-child blocks) is described based on unit of physical blocks. However, in another exemplary embodiment of the present invention, when the flash memory chip 140 is managed in unit of physical unit which contains a plurality of physical blocks, foregoing alternation, selection, and substitution operations are then carried out based on the unit of physical units.

Referring to FIG. 2 again, in the present exemplary embodiment, the controller 110 is connected to the flash memory chip 140 through a data bus 149. The flash memory chip 140 has a plurality of flash memory dies (i.e., the first flash memory die 142, the second flash memory die 144, the third flash memory die 146, and the fourth flash memory die 148). Thus, since as described above, the time required for programming the flash memory dies is far more than the time required for transmitted data through the data bus 149, the microprocessor unit 110a of the controller 110 can write data by executing the machine instructions of the memory management module 110b through an interleaving programming method to improve the data writing efficiency of the flash memory storage system 100.

For example, the controller 110 divides a data DATA to be written into a plurality of sub data DATA1, DATA2, DATA3, and DATA4 based on the writing unit (for example, pages) and transmits the sub data into different flash memory dies through the data bus 149 in an interleaving manner. To be specific, the controller 110 first transmits the sub data DATA1 into the buffer of the first flash memory die 142 to allow the first flash memory die 142 to program the sub data DATA1. After that, when the first flash memory die 142 is busy, the controller 110 transmits the sub data DATA2 into the buffer of the second flash memory die 144 to allow the second flash memory die 144 to program the sub data DATA2. Thereafter, when both the first flash memory die 142 and the second flash memory die 144 are busy, the controller 110 transmits the sub data DATA3 into the buffer of the third flash memory die 146 to allow the third flash memory die 146 to program the sub data DATA3. Eventually, when the first flash memory die 142, the second flash memory die 144, and the third flash memory die 146 are all busy, the controller 110 transmits the sub data DATA4 into the buffer of the fourth flash memory die 148 to allow the fourth flash memory die 148 to program the sub data DATA4. As described above, because part of the data is written synchronously, the time required for writing data by the flash memory storage system 100 is shortened.

It should be mentioned that in the present exemplary embodiment, when the controller 110 transmits a large quantity of data to be written at continuous logical addresses from the cache 130 to the flash memory chip 140 and executes the interleaving programming method, the controller 110 reads the data from the cache 130 and transmits the data to the flash memory chip 140 in an alternative (or interleaving) manner.

To be specific, the controller 110 sequentially sorts the sector data (i.e., data in unit of sectors) to be written at continuous logical addresses (i.e., logical sectors) in the cache 130 and sequentially groups the sorted sector data into block data based on the size of the logical blocks. Then, the controller 110 reads the sector data from the cache 130 in an interleaving manner and transmits the data into the flash memory dies of the flash memory chip 140 in unit of pages, wherein in the present exemplary embodiment, each page contains 4 sector data.

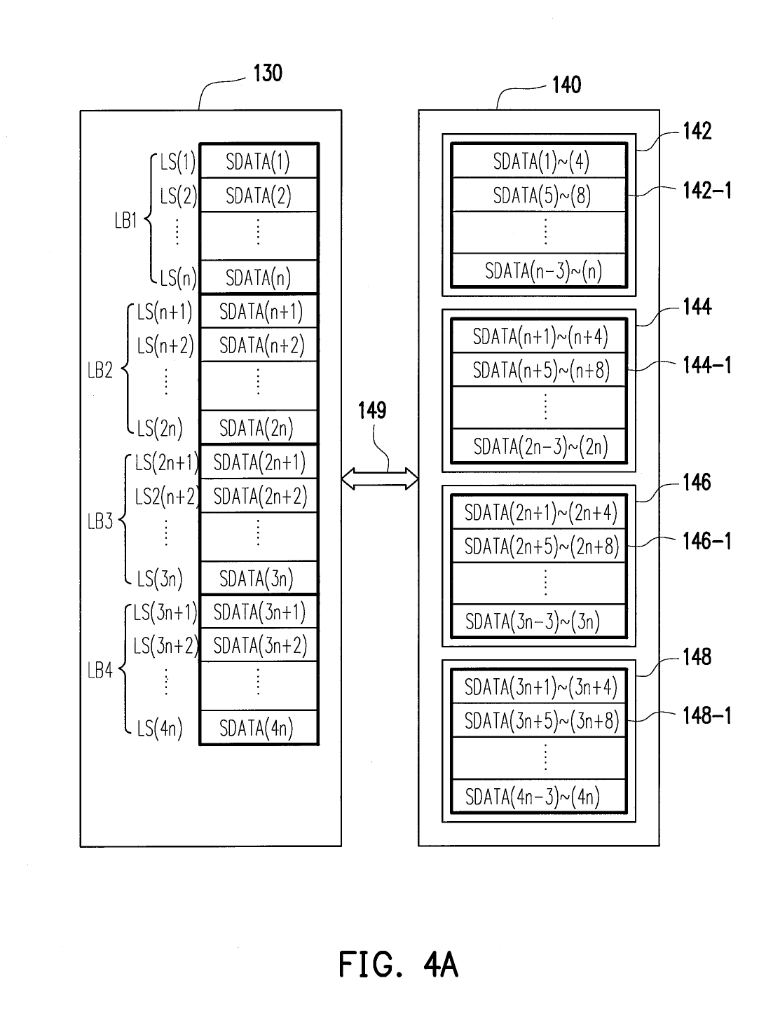

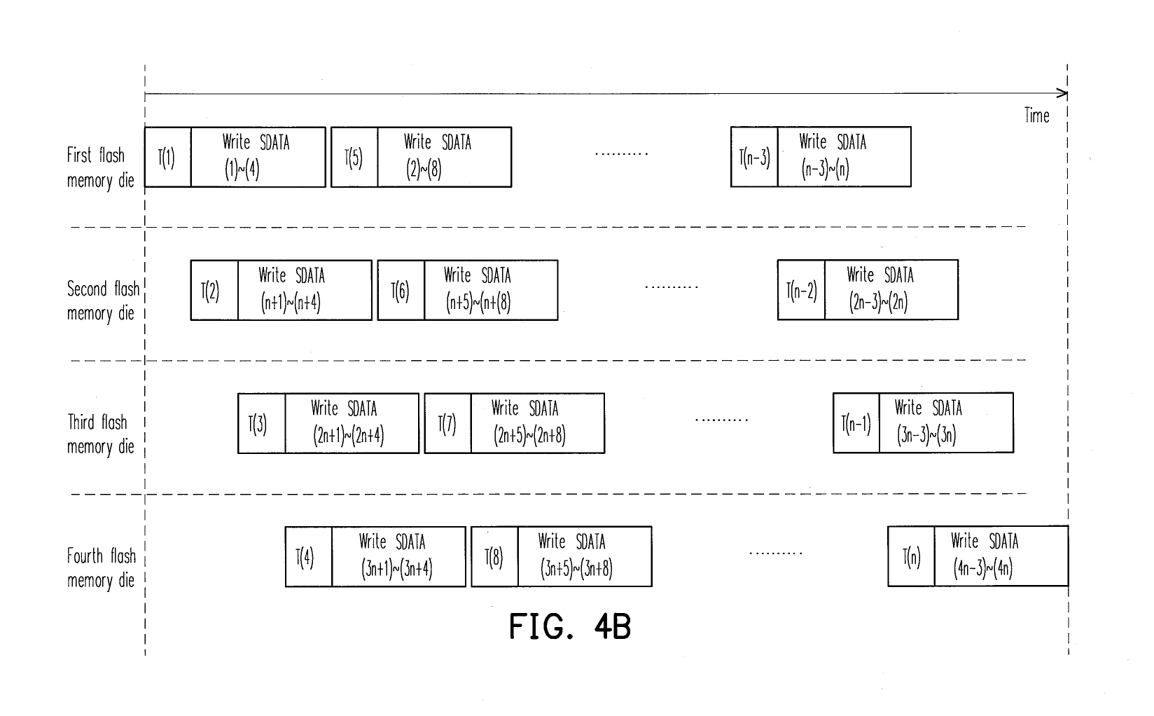

FIG. 4A illustrates an example about how data is transmitted from a cache to a flash memory chip according to an exemplary embodiment of the present invention, and FIG. 4B is a timing diagram of an interleaving programming method performed in the example illustrated in FIG. 4A. For the convenience of description, only some of the sector addresses of the cache 130 are illustrated in FIG. 4A. However, it should be understood that the cache 130 may further include other sector addresses. Similarly, only some of the physical blocks of the first flash memory die 142, the second flash memory die 144, the third flash memory die 146, and the fourth flash memory die 148 are illustrated in FIG. 4A. However, it should be understood that the first flash memory die 142, the second flash memory die 144, the third flash memory die 146, and the fourth flash memory die 148 may further include other physical blocks.

Referring to FIG. 4A and FIG. 4B, it is assumed that the flash memory storage system 100 has received the sector data SDATA(1)˜(4n) to be written into continuous logical addresses from the host system 200 and stores the data temporarily into the cache 130. The controller 110 sequentially arranges the sector data SDATA(1)˜(4n) according to the sequence of the logical sectors LS(1)˜LS(4n) and groups the sector data SDATA(1)˜(4n) in unit of logical blocks, wherein the sector data SDATA(1)˜(4n) are respectively grouped into four logical blocks LB1˜LB4.

When the controller 110 transmits the sector data SDATA(1)˜(4n) to the flash memory chip 140 through the data bus 149, the controller 110 transmits the data in the logical sectors LS(1)˜LS(4) (i.e., the sector data SDATA(1)˜(4)) into the buffer of the physical block 142-1 in the first flash memory die 142 in unit of pages (as the transmission T(1) in FIG. 4B). Next, when the first flash memory die 142 is busy (i.e., for writing the data), the controller 110 transmits the data in the logical sectors LS(n+1)˜LS(n+4) (i.e., the sector data SDATA(n+1)˜(n+4)) into the buffer of the physical block 144-1 in the second flash memory die 144 (as the transmission T(2) in FIG. 4B). After that, when the first flash memory die 142 and the second flash memory die 144 are both busy, the controller 110 transmits the data in the logical sectors LS(2n+1)˜LS(2n+4) (i.e., the sector data SDATA(2n+1)˜(2n+4)) into the buffer of the physical block 146-1 in the third flash memory die 146 (as the transmission T(3) in FIG. 4B). When the first flash memory die 142, the second flash memory die 144, and the third flash memory die 146 are busy, the controller 110 transmits the data in the logical sectors LS(3n+1)˜LS(3n+4) (i.e., the sector data SDATA(3n+1)˜(3n+4)) into the buffer of the physical block 148-1 in the fourth flash memory die 148 (as the transmission T(4) in FIG. 4B).

After that, the controller 110 determines whether the first flash memory die 142 has finished writing the sector data SDATA(1)˜(4), and if the first flash memory die 142 has finished writing the sector data SDATA(1)˜(4) (i.e., is not busy), the controller 110 transmits the data in the logical sectors LS(2)˜LS(8) (i.e., the sector data SDATA(2)˜(8)) into the buffer of the physical block 142-1 in the first flash memory die 142 (as the transmission T(5) in FIG. 4B). Then, the controller 110 determines whether the second flash memory die 144 has finished writing the sector data SDATA(n+1)˜(n+4), and if the second flash memory die 144 has finished writing the sector data SDATA(n+1)˜(n+4), the controller 110 transmits the data in the logical sectors LS(n+5)˜LS(n+8) (i.e., the sector data SDATA(n+5)˜(n+8)) into the buffer of the physical block 144-1 in the second flash memory die 144 (as the transmission T(6) in FIG. 4B). Next, the controller 110 determines whether the third flash memory die 146 has finished writing the sector data SDATA(2n+1)˜(2n+4), and if the third flash memory die 146 has finished writing the sector data SDATA(2n+1)˜(2n+4), the controller 110 transmits the data in the logical sectors LS(2n+5)˜LS(2n+8) (i.e., the sector data SDATA(2n+5)˜(2n+8)) into the buffer of the physical block 146-1 in the third flash memory die 146 (as the transmission T(7) in FIG. 4B). Thereafter, the controller 110 determines whether the fourth flash memory die 148 has finished writing the sector data SDATA(3n+1)˜(3n+4), and if the fourth flash memory die 148 has finished writing the sector data SDATA(3n+1)˜(3n+4), the controller 110 transmits the data in the logical sectors LS(3n+5)˜LS(3n+8) (i.e., the sector data SDATA(3n+5)˜(3n+8)) into the buffer of the physical block 148-1 in the fourth flash memory die 148 (as the transmission T(8) in FIG. 4B). As described above, the process goes on until the controller 110 transmits all the data in the logical sectors LS(1)˜LS(4n) into the flash memory chip 140 (i.e., all the transmissions T(1)˜T(n) in FIG. 4B are completed).

As described above, through the interleaving programming method, the sector data SDATA(1)˜(4n) is alternatively transmitted into the first flash memory die 142, the second flash memory die 144, the third flash memory die 146, and the fourth flash memory die 148 of the flash memory chip 140 through the data bus 149 in an interleaving and repeating manner. Thereby, the controller 110 can transmit the sector data belonging to the same block data into the physical blocks of the same flash memory die.

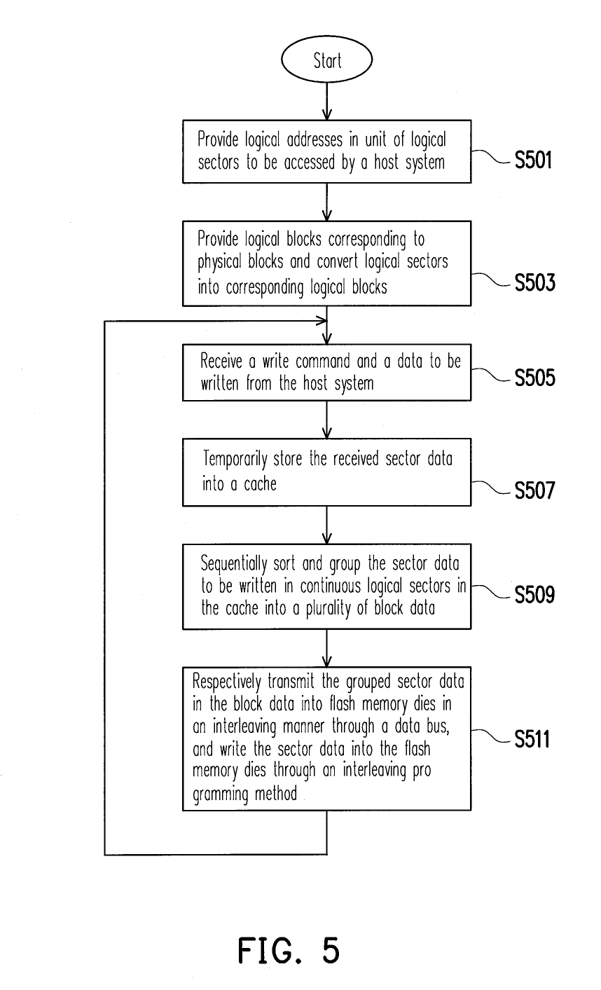

FIG. 5 is a flowchart illustrating a plurality of data transmission steps according to an exemplary embodiment of the present invention, wherein these steps are accomplished by executing the machine instructions of the memory management module 110b through the microprocessor unit 110a of the controller 110. It should be understood that the data transmission steps in the present invention are not limited to the execution order illustrated in FIG. 5, and those skilled in the art should be able to change the order of the data transmission steps without departing the scope and spirit of the present invention. In addition, the present exemplary embodiment focuses on the data transmission method for writing data into the flash memory chip 140 through an interleaving programming method, the steps illustrated in FIG. 5 are only described regarding the process of a write command. The process of read command or other commands can be implemented by referring to the conventional technique therefore will not be described herein.

Referring to FIG. 5, when the flash memory storage system 100 is connected to the host system 200 and is turned on, in step S501, the controller 110 provides logical addresses in unit of logical sectors to the host system 200 to allow the host system 200 to access data. As described above, herein providing the logical addresses in unit of logical sectors is to match the access characteristic of the host system 200.

In step S503, the controller 110 provides logical blocks and converts the logical sectors into corresponding logical blocks. As described above, in the present exemplary embodiment, the flash memory chip 140 is accessed in unit of physical blocks. Thus, the controller 110 needs to convert the logical sectors accessed by the host system 200 into logical blocks based on the size of the physical blocks.

Next, in step S505, the controller 110 receives a write command and a data to be written from the host system 200. After that, in step S507, the controller 110 stores the data temporarily into the cache 130.

When the controller 110 is about to program (i.e., write) the data in the cache 130 into the flash memory chip 140, in step S509, the controller 110 sequentially sorts and groups the sector data to be written in continuous logical sectors in the cache 130 into a plurality of block data. In particular, when the controller 110 groups the sector data, the controller 110 maps the block data respectively to the logical blocks. If the grouped block data is not enough for the corresponding logical block (i.e., only part of the data in the logical block is to be updated), the controller 110 combines the old valid data in the corresponding logical block and the new data to be written into a complete block data (i.e., the operation illustrated in FIG. 3B), wherein the data combination process can be completed in the cache 130 or the buffer memory 110d of the controller 110.

Eventually, in step S511, the controller 110 respectively transmits the sector data in the grouped block data through the data bus 149 into the flash memory chip 140 in an interleaving manner and writes the sector data into the flash memory dies 142, 144, 146, and 148 through the interleaving programming method. After that, the data transmission process returns to step S505 to wait for the next write command. Even though not shown in FIG. 5, those skilled in the art should be able to understand that the data transmission process illustrated in FIG. 5 is terminated when a shutdown or power-off command is received.

It should be mentioned that as described above, the physical blocks in the flash memory chip 140 are alternatively used for storing data written into the logical blocks by the host system 200. Thus, in order to distribute new data evenly into the flash memory dies when the physical blocks are alternated, when the controller 110 selects a physical block from the spare area 206 for substituting the physical block in the data area 204 corresponding to the logical block to be written, the controller 110 determines which flash memory die (i.e., the first flash memory die 142, the second flash memory die 144, the third flash memory die 146, or the fourth flash memory die 148) the physical block to be updated in the data area 204 belongs to and selects only the physical block corresponding to the specific flash memory die from the spare area 206 to carry out foregoing substitution operation.

To be specific, the spare area 206 is identified as a spare area 206a, a spare area 206b, a spare area 206c, and a spare area 206d corresponding to the first flash memory die 142, the second flash memory die 144, the third flash memory die 146, and the fourth flash memory die 148. The physical block is selected from the spare area 206a when the physical block to be updated belongs to the first flash memory die 142, the physical block is selected from the spare area 206b when the physical block to be updated belongs to the second flash memory die 144, the physical block is selected from the spare area 206c when the physical block to be updated belongs to the third flash memory die 146, and the physical block is selected from the spare area 206d when the physical block to be updated belongs to the fourth flash memory die 148.

In particular, since in the present exemplary embodiment, the physical block is only selected from the corresponding spare area for opening mother-child blocks, the controller 110 may open child blocks for five parent blocks belonging to the same flash memory die at the same time. Thus, in the present exemplary embodiment, enough number of physical blocks has to be disposed in each of the spare areas (i.e., the spare area 206a, the spare area 206b, the spare area 206c, and the spare area 206d) for processing five sets of mother-child blocks. In addition, the controller 110 respectively establishes and maintains a logical-physical address mapping table for the first flash memory die 142, the second flash memory die 144, the third flash memory die 146, and the fourth flash memory die 148 of the flash memory chip 140 for recording foregoing mapping relationship. Namely, in the present exemplary embodiment, four logical-physical address mapping tables are recorded and updated.

In addition, since the first flash memory die 142, the second flash memory die 144, the third flash memory die 146, and the fourth flash memory die 148 respectively have an independent logical-physical address mapping table, in another exemplary embodiment of the present invention, a wear levelling process may be individually performed to the first flash memory die 142, the second flash memory die 144, the third flash memory die 146, and the fourth flash memory die 148. The wear levelling process is a technique well understood by those skilled in the art therefore will not be described herein.

Moreover, because when the controller 110 opens mother-child blocks, the mother-child blocks belong to the same flash memory die, in another exemplary embodiment of the present invention, the controller 110 can execute a copyback instruction to speed up the data moving between the mother-child blocks (as shown in FIG. 3B).

As described above, the present invention provides a data transmission method, wherein data in a cache is alternatively transmitted into the flash memory dies of a flash memory chip in unit of logical blocks in a discontinuous manner. Thereby, data in continuous logical addresses will not be written into different flash memory dies. Accordingly, data writing efficiency can be increased when subsequently the data is updated and the number of erasing operations performed to the physical blocks can be reduced. Moreover, according to the present invention, physical blocks used alternatively for storing data belong to the same flash memory die, and accordingly a copyback instruction can be executed to speed up the writing of data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data transmission method, suitable for a flash memory storage system, wherein the flash memory storage system has a plurality of physical blocks, the physical blocks are grouped into a plurality of flash memory groups, and the flash memory groups are connected to a data bus, the data transmission method comprising:
providing a plurality of logical sectors and a plurality of logical blocks, wherein the logical sectors are mapped to the logical blocks, and the logical blocks are mapped to the physical blocks;
sequentially grouping a plurality of sector data to be written in the continuous logical sectors into a plurality of block data, wherein each of the block data is corresponding to one of the logical blocks; and
transmitting and writing the sector data belonging to the same block data into the same physical block.

2. The data transmission method according to claim 1, further comprising respectively transmitting the sector data into the flash memory groups in unit of the block data through the data bus in an interleaving manner, wherein at least a part of the sector data is synchronously written into the flash memory groups.

3. The data transmission method according to claim 2, wherein each of the flash memory groups is formed of at least one flash memory die, and a part of the physical blocks in each of the at least one flash memory die is defined as a spare area,
wherein the sector data belonging to the same block data is written into the physical block selected from the spare area of the same flash memory die.

4. The data transmission method according to claim 3, further comprising individually recording a logical-physical address mapping table for each of the at least one flash memory die.

5. The data transmission method according to claim 3, further comprising individually executing a wear levelling process to each of the at least one flash memory die.

6. The data transmission method according to claim 3, further comprising executing a copyback instruction in each of the at least one flash memory dies to copy data between the physical blocks in each of the at least one flash memory die.

7. A controller, suitable for a flash memory storage system, wherein the flash memory storage system has a plurality of physical blocks, the physical blocks are grouped into a plurality of flash memory groups, and the flash memory groups are connected to a data bus, the controller comprising:
a microprocessor unit;
a flash memory interface, coupled to the microprocessor unit;
a buffer memory, coupled to the microprocessor unit; and
a memory management module, coupled to the microprocessor unit, wherein the memory management module has a plurality of machine instructions to perform a plurality of data transmission steps to the flash memory storage system, and the data transmission steps comprise:
providing a plurality of logical sectors and a plurality of logical blocks, wherein the logical sectors are mapped to the logical blocks, and the logical blocks are mapped to the physical blocks;
sequentially grouping a plurality of sector data to be written in the continuous logical sectors into a plurality of block data, wherein each of the block data is corresponding to one of the logical blocks; and
transmitting and writing the sector data belonging to the same block data into the same physical block.

8. The controller according to claim 7, wherein the data transmission steps further comprise respectively transmitting the sector data into the flash memory groups in unit of the block data through the data bus in an interleaving manner, wherein at least a part of the sector data is synchronously written into the flash memory groups.

9. The controller according to claim 8, wherein each of the flash memory groups is formed of at least one flash memory die, and a part of the physical blocks in the at least one flash memory die is defined as a spare area,
wherein the sector data belonging to the same block data is written into the physical blocks selected from the spare area of the same flash memory die.

10. The controller according to claim 9, wherein the data transmission steps further comprise individually recording a logical-physical address mapping table for each of the at least one flash memory die.

11. The controller according to claim 9, wherein the data transmission steps further comprise individually executing a wear levelling process to each of the at least one flash memory die.

12. The controller according to claim 9, wherein the data transmission steps further comprise executing a copyback instruction in each of the at least one flash memory die to copy data between the physical blocks in each of the at least one flash memory die.

13. The controller according to claim 7, wherein the flash memory storage system is a flash drive, a flash memory card, or a solid state drive (SSD).

14. A flash memory storage system, comprising:
a plurality of physical blocks, grouped into a plurality of flash memory groups;
at least one data bus, connected to the flash memory groups;
a cache;
a connector; and
a controller, electrically connected to the data bus, the cache, and the connector, wherein the controller executes a plurality of machine instructions of a memory management module to perform a plurality of data transmission steps, and the data transmission steps comprise:
providing a plurality of logical sectors and a plurality of logical blocks, wherein the logical sectors are mapped to the logical blocks, and the logical blocks are mapped to the physical blocks;
sequentially grouping a plurality of sector data to be written in the continuous logical sectors into a plurality of block data, wherein each of the block data is corresponding to one of the logical blocks; and
transmitting and writing the sector data belonging to the same block data into the same physical block.

15. The flash memory storage system according to claim 14, wherein the data transmission steps further comprise respectively transmitting the sector data into the flash memory groups in unit of the block data through the data bus in an interleaving manner, wherein at least a part of the sector data is synchronously written into the flash memory groups.

16. The flash memory storage system according to claim 15, wherein each of the flash memory groups is formed of at least one flash memory die, and a part of the physical blocks in the at least one flash memory die is defined as a spare area,
wherein the sector data belonging to the same block data is written into the physical blocks selected from the spare area of the same flash memory die.

17. The flash memory storage system according to claim 16, wherein the data transmission steps further comprise individually recording a logical-physical address mapping table for each of the at least one flash memory die.

18. The flash memory storage system according to claim 16, wherein the data transmission steps further comprise individually executing a wear levelling process to each of the at least one flash memory die.

19. The flash memory storage system according to claim 16, wherein the data transmission steps further comprise executing a copyback instruction in each of the flash memory dies to copy data between the physical blocks in each of the at least one flash memory die.
